(19) United States
(12) Patent Application Publication
(10) Pub. No.: US 2026/0045229 A1
(43) Pub. Date: Feb. 12, 2026

(54) DISPLAY DEVICE AND DRIVING METHOD THEREOF

(71) Applicant: LG Display Co., Ltd., Seoul (KR)

(72) Inventors: Woo Kyu SANG, Paju-si (KR); Young Gyu KIM, Paju-si (KR); Tae Hun KIM, Paju-si (KR)

(73) Assignee: LG Display Co., Ltd., Seoul (KR)

(21) Appl. No.: 19/269,648

(22) Filed: Jul. 15, 2025

(30) Foreign Application Priority Data
Aug. 12, 2024 (KR) 10-2024-0107814

(51) Int. Cl. G09G 3/3291; G09G 3/3266

(52) U.S. Cl. CPC G09G 3/3291; G09G 3/3266; G09G 2310/027; G09G 2320/0233; G09G 2320/0247; G09G 2320/0271; G09G 2330/021

(57) ABSTRACT

A display device includes a display panel including an active area configured with a plurality of pixels, a source driver configured to divide gamma reference voltages to generate a data voltage for implementing an image gray level and supply the data voltage to the pixels of the active area, and a reset voltage control circuit configured to change an anode reset voltage for discharging light emitting elements of the plurality of pixels to be different from a default level, at a scene change time where the amount of image gray variation is a reference value or more with respect to at least a partial region of the active area, and supply the anode reset voltage to pixels of the at least partial region of the active area.

### CROSS-REFERENCE TO RELATED APPLICATIONS

This application claims the benefit of the Korean Patent Application No. 10-2024-0107814 filed on Aug. 12, 2024, which is hereby incorporated by reference as if fully set forth herein.

### BACKGROUND

### Technical Field

The present disclosure relates to a display device and a driving method thereof.

### Description of the Related Art

Display devices include a plurality of pixels arranged as a matrix type and implementing an image gray level corresponding to image data by using the pixels. Each of the pixels includes a light emitting element, and luminance corresponding to an image gray level is implemented based on the amount of light emission of the light emitting element.

A gray response time of a light emitting element may be slowed under a condition where the amount of variation of luminance implemented in a pixel is large (for example, at a scene change time where an image gray level is changed from a white gray level to a black gray level, or is changed from the black gray level to the white gray level), and due to this, blurring may be recognized by a user.

### BRIEF SUMMARY

The present disclosure provides a display device and a driving method thereof, which, among others, may increase a gray response time of a light emitting element at a scene change time to enhance display quality.

Moreover, the present disclosure provides a display device and a driving method thereof, which may increase a gray response time of a light emitting element at a scene change time, and thus, may enhance display quality and may implement low power consumption.

As embodied and broadly described herein, a display device includes: a display panel including an active area configured with a plurality of pixels; a source driver configured to divide gamma reference voltages to generate a data voltage for implementing an image gray level and supply the data voltage to the pixels of the active area; and a reset voltage control circuit configured to change an anode reset voltage for discharging light emitting elements of the plurality of pixels to be different from a default level, at a scene change time where the amount of image gray variation is a reference value or more with respect to at least a partial region of the active area, and supply the anode reset voltage to pixels of the at least partial region of the active area.

### BRIEF DESCRIPTION OF THE SEVERAL VIEWS OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram illustrating a display device according to an embodiment of the present disclosure;

FIG. 2 is a diagram illustrating an example of variable refresh rate (VRR) technology applied to a display device according to an embodiment of the present disclosure;

FIG. 3 is a diagram illustrating a pixel according to an embodiment of the present disclosure;

FIG. 4 is a driving waveform diagram of a pixel in a refresh frame;

FIG. 5 is a diagram showing a driving waveform of a pixel in a skip frame;

FIG. 6 is a diagram illustrating a relationship between an anode reset voltage and a gray response time of a light emitting element at a scene change time;

FIG. 7 is a diagram illustrating an example where an anode reset voltage is changed to be different from a default level at only a scene change time, and the anode reset voltage is maintained at the default level at the other time;

FIG. 8 is a diagram illustrating a gray falling condition of a scene change time where an image gray level is changed from a white image of an N^{th} frame to a black image of an (N+1)^{th} frame;

FIG. 9 is a diagram illustrating a case where an anode reset voltage is maintained at a default level in an N^{th} frame just before the scene change time of FIG. 8;

FIG. 10 is a diagram illustrating a case where an anode reset voltage is down-shifted from a default level to a second level in an (N+1)^{th} frame corresponding to the scene change time of FIG. 8;

FIG. 11 is a diagram illustrating a gray rising condition of a scene change time where an image gray level is changed from a black image of an N^{th} frame to a white image of an (N+1)^{th} frame;

FIG. 12 is a diagram illustrating a case where an anode reset voltage is maintained at a default level in an N^{th} frame just before the scene change time of FIG. 11;

FIG. 13 is a diagram illustrating a case where an anode reset voltage is up-shifted from a default level to a third level in an (N+1)^{th} frame corresponding to the scene change time of FIG. 11;

FIG. 14 is a diagram illustrating a case where a white image pattern is scrolled down by using a background as a black image in one active area for a scene change time;

FIG. 15 is a diagram illustrating an example where an anode reset voltage is changed to be different from a default level at a gray falling position and a gray rising position of a scene change time, and the anode reset voltage is maintained at the default level at the other position;

FIG. 16 is a diagram illustrating a case where a gray falling position and a gray rising position of a scene change time are temporally changed based on a scroll-down operation of a white image pattern having a black image as a background;

FIGS. 17 and 18 are diagrams illustrating an example where an anode reset voltage is differently changed at a gray falling position and a gray rising position based on a scroll-down operation in an N^{th} frame in the middle of a scene change time;

FIG. 19 is a diagram illustrating a case where an anode reset voltage is changed based on a gray falling position and a gray rising position shifted by pixel row units;

FIG. 20 is a diagram illustrating a configuration of a reset voltage control circuit;

FIG. 21 is a diagram illustrating a connection configuration between a reset voltage control circuit, a gamma memory, a gamma voltage circuit, and a source driver; and

FIG. 22 is a diagram illustrating a configuration of a gamma memory.

### DETAILED DESCRIPTION

Hereinafter, the present disclosure will be described more fully with reference to the accompanying drawings, in which exemplary embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art.

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

The shapes, sizes, ratios, angles, numbers and the like disclosed in the drawings for description of various embodiments of the present disclosure to describe embodiments of the present disclosure are merely exemplary and the present disclosure is not limited thereto. Like reference numerals refer to like elements throughout. Throughout this specification, the same elements are denoted by the same reference numerals. As used herein, the terms “comprise,” “having,” “including” and the like suggest that other parts can be added unless the term “only” is used. As used herein, the singular forms “a,” “an,” and “the” are intended to include the plural forms as well, unless context clearly indicates otherwise.

Elements in various embodiments of the present disclosure are to be interpreted as including margins of error even without explicit statements.

In describing a position relationship, for example, when a position relation between two parts is described as “on˜,” “over˜,” “under˜,” and “next˜,” one or more other parts may be disposed between the two parts unless “just” or “direct” is used.

It will be understood that, although the terms “first,” “second,” etc., may be used herein to describe various elements, these elements should not be limited by these terms. These terms are only used to distinguish one element from another. For example, a first element could be termed a second element, and, similarly, a second element could be termed a first element, without departing from the scope of the present disclosure.

In the following description, when the detailed description of the relevant known function or configuration is determined to unnecessarily obscure the important point of the present disclosure, the detailed description will be omitted. Hereinafter, embodiments of the present disclosure will be described in detail with reference to the accompanying drawings.

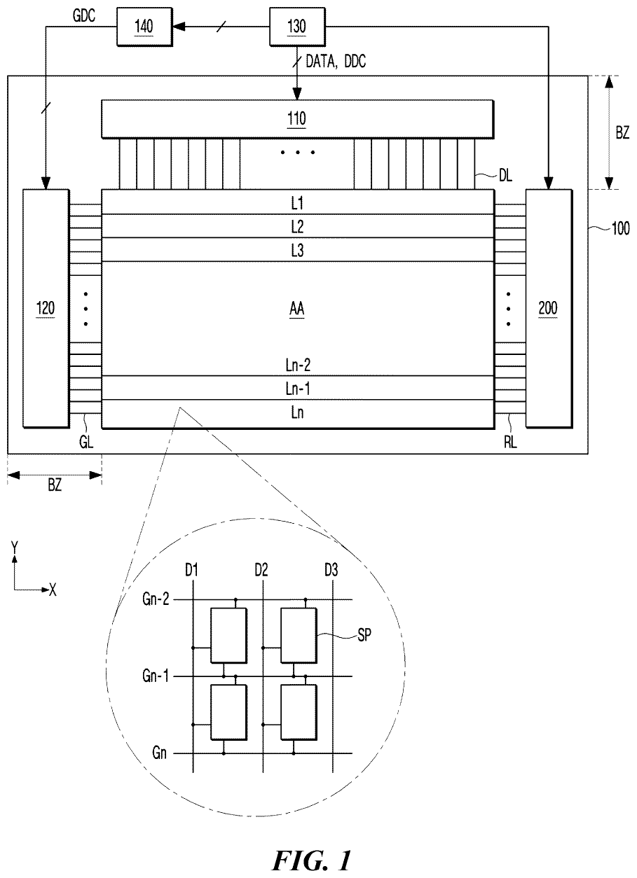

FIG. 1 is a diagram illustrating a display device according to an embodiment of the present disclosure.

Referring to FIG. 1, the display device according to an embodiment of the present embodiment may be an organic light emitting display device, but is not limited thereto. A display panel 100 may include an active area AA which reproduces an input image. The active area AA may include a pixel array which displays pixel data (hereinafter referred to as “image data”) DATA of an input image. The pixel array may include a plurality of data lines DL, a plurality of gate lines GL intersecting with the data lines DL, and a plurality of pixels SP.

The pixels SP may be arranged on the active area AA in a matrix type defined by intersections between the data lines DL and the gate lines GL. The pixels SP may be arranged as various types such as a stripe type and a diamond type on the active area AA, based on positions of the pixels SP emitting lights of the same color.

The pixel array may include a plurality of pixel columns and a plurality of pixel rows L1 to Ln intersecting with the pixel columns. Each of the pixel columns may include pixels SP which are arranged in a Y-axis direction. A pixel row may include pixels SP which are arranged in an X-axis direction. One vertical period may be one frame period needed for writing image data DATA of one frame in all pixels of the active area. One horizontal period may be a time obtained by dividing one frame period by the number of pixel rows L1 to Ln. One horizontal period may be a time needed for writing the image data DATA of one pixel row, sharing a gate line GL, in pixels SP of one pixel row.

The pixels SP may include a first pixel which generates red (R) light, a second pixel which generates green (G) light, and a third pixel which generates blue (B) light, for various color combinations. The pixels SP may further include a fourth pixel which generates white (W) light. The first to third pixels or the first to fourth pixels may configure one unit pixel.

Each of the pixels SP may be implemented with a pixel circuit connected to a data line DL and a gate line GL. The pixel circuit may include a light emitting element, a driving transistor, one or more switch transistors, and a capacitor. The light emitting element may be implemented as an organic light emitting diode (OLED). A driving current applied to the light emitting element may be controlled based on a gate-source voltage of the driving transistor. The gate-source voltage of the driving transistor may be determined by a data voltage corresponding to the image data DATA. In FIG. 1, “D1 to D3” illustrated in a circle may be data lines, and “Gn-2 to Gn” may be gate lines.

The pixel circuit may sample a threshold voltage of the driving transistor in the middle of a pixel programming operation which is performed in one frame period and may allow a sampled threshold voltage to be reflected in a gate-source voltage (hereinafter referred to as Vgs) of the driving transistor, and thus, may prevent a driving current from being distorted due to a threshold voltage variation of the driving transistor.

The pixel circuit may be implemented as a hybrid type. In a hybrid-type pixel circuit, semiconductor layers of some transistors may include low-temperature polycrystalline silicon (hereinafter referred to as LTPS), and semiconductor layers of the other transistors may be configured with oxide.

The pixel circuit may be driven based on variable refresh rate (VRR) technology. VRR technology may vary a refresh rate of image data DATA, based on an attribute of an image. According to VRR technology, as a change in image decreases, a data refresh cycle may increase, and thus, power consumption may be reduced.

To implement the VRR variable technology, one or more skip frames may be provided between adjacent refresh frames. A data refresh operation may be performed in the refresh frame and may not be performed in the skip frame. A refresh rate (i.e., a frame frequency) may be determined based on the number of skip frames provided between adjacent refresh frames.

A data refresh operation including pixel initialization and data programming may be performed in a refresh frame. The light emitting element may be turned off when performing a data refresh operation, and at this time, an anode reset operation where the light emitting element is initialized into an anode reset voltage may be performed.

A data refresh operation on the pixels SP may be omitted (or skipped) in a skip frame, and a data refresh condition (Vgs, the driving current, etc.) which is set in a refresh frame may be maintained. An anode reset operation for turning off the light emitting element may be performed in the skip frame. Accordingly, a time length where the light emitting element is turned on in the skip frame may be substantially equal to a time length where the light emitting element is turned on in the refresh frame.

The pixels SP may be further connected to reset voltage lines RL, for an anode reset operation, and may be supplied with the anode reset voltage through the reset voltage lines RL. The reset voltage lines RL may be independently patterned by pixel row units. That is, one reset voltage line RL may be connected to a plurality of pixels SP configuring one pixel row. The reset voltage lines RL may be independently driven in a pixel row unit.

In each of the refresh frame and the skip frame, while the anode reset operation is being performed, an on-bias stress (OBS) operation may be performed on the driving transistor.

In the hybrid-type pixel circuit according to the present embodiment, the OBS operation may be for preventing an image quality defect caused by a hysteresis characteristic of the driving transistor. At a scene change time where the image data DATA is changed from a black gray level to a white gray level, or is rapidly from the white gray level to the black gray level, a gray response time may increase in a first frame where a white image (or a black image) is reproduced, due to a time needed for varying the hysteresis characteristic of the driving transistor, and thus, a dim first frame (DFF) phenomenon may occur. At this time, when the Vgs of the driving transistor increases by applying an OBS voltage to one electrode of the driving transistor, a DFF characteristic may be alleviated. This may be referred to as an OBS operation.

The scene change time in the present disclosure may be defined as a frame where the amount of variation of an image gray level is a reference value or more with respect to at least a partial region of an active area. Therefore, the amount of gray variation in a broad range as well as the amount of variation between a black gray level and a white gray level may be used to define the scene change time.

At the scene change time, a gray response time of a light emitting element may be slowed due to an insufficient reset on a parasitic capacitor of the light emitting element, and due to this, blurring may be recognized. The gray response time of the light emitting element may not be compensated for based on an OBS operation. This may be because the OBS operation is for compensating for a hysteresis characteristic of a driving transistor.

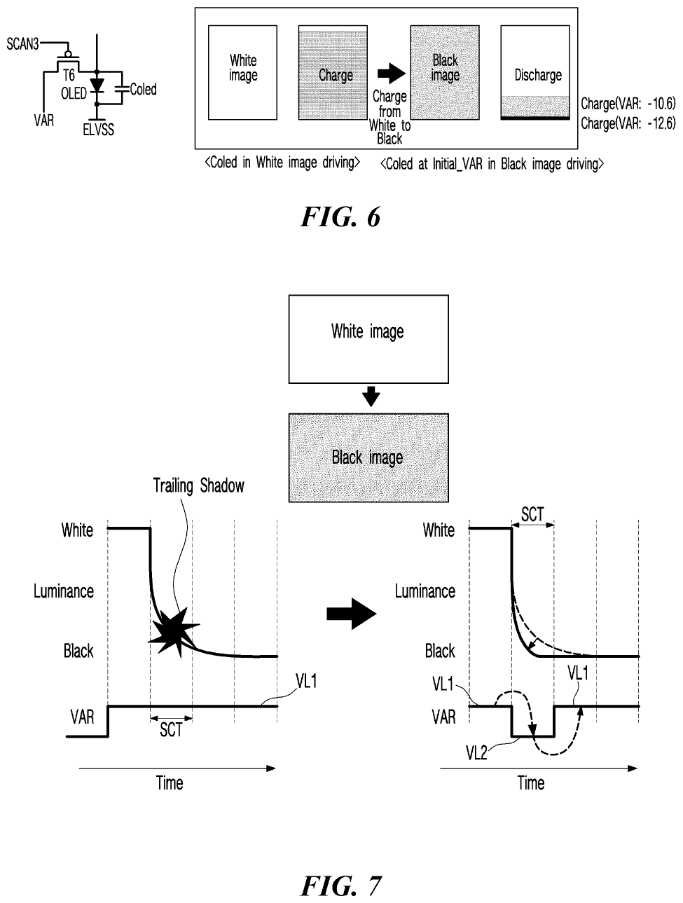

To increase a gray response time of a light emitting element, by using a reset voltage control circuit 200 according to the present disclosure, an anode reset voltage for discharging light emitting elements of pixels SP may be changed to be different from a default level at a scene change time where the amount of image gray variation is defined to be a reference value or more with respect to at least a partial region of an active area, and thus, a discharge effect on a parasitic capacitor of a light emitting element may increase. Here, the scene change time may denote a first frame where a rapid gray change is performed. This will be described in detail with reference to FIG. 6.

Because the reset voltage control circuit 200 changes the anode reset voltage to be different from the default level at only the scene change time and recovers the anode reset voltage to the default level in the other frames except the scene change time, thereby reducing a problem where power consumption increases due to a change in anode reset voltage. This will be described in detail with reference to FIGS. 7 to 20.

Touch sensors may be further disposed on the display panel 100. The touch sensors may be arranged as an on-cell or add-on type on the active area AA of the display panel 100, or may be implemented as in-cell type touch sensors embedded in the pixel array. A touch input may be sensed through only the pixels SP even without the touch sensors, and in this case, the touch sensors may be omitted.

A display panel driver may include a source driver 110 and a gate driver 120. The display panel driver may write the image data DATA in the pixels SP of the display panel 100 in synchronization with a gate signal, based on control by a timing controller 130.

The source driver 110 may convert the image data DATA, received from the timing controller 130, into gamma compensation voltages by using a digital-to-analog converter (DAC) to generate data voltages. The source driver 110 may supply the data voltages to the data lines DL. The data voltages may be supplied to the data lines DL and may be applied to gate electrodes of the driving transistors through the switch transistors of the pixels SP. The source driver 110 may be implemented with a plurality of source drive integrated circuits (ICs).

A gamma voltage circuit connected to (or integrated into) the DAC of the source driver 110 may be provided. The gamma voltage circuit may generate gamma tap voltages and may supply the gamma tap voltages to the DAC of the source driver 110. The gamma tap voltages may be gamma reference voltages. The DAC of the source driver 110 may divide the gamma reference voltages to generate data voltages.

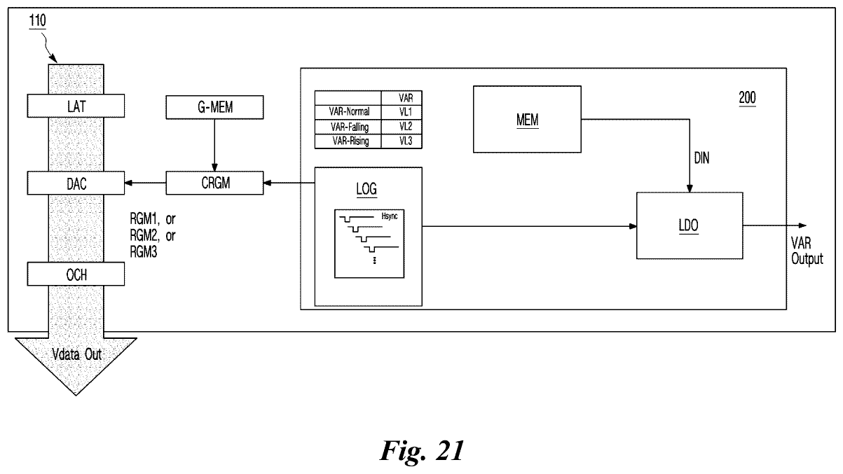

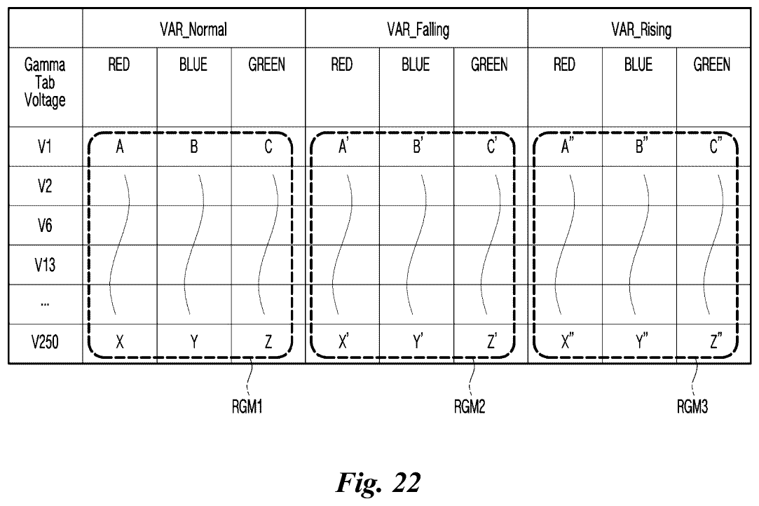

The gamma voltage circuit may output gamma tap voltages applied to the scene change time to be different from gamma tap voltages applied to the other frames except the scene change time, and thus, may prevent a problem where color coordinates are warped because the anode reset voltage is changed at the scene change time. This will be described in detail with reference to FIGS. 21 and 22.

The gate driver 120 may be implemented as a single bank type where the gate driver 120 is disposed in a one-side bezel region BZ of the active area AA, or a double bank type where the gate driver 120 is disposed in both bezel regions BZ of the active area AA. The single bank type may be relatively more favorable to implement a narrow bezel. The double bank type may be relatively more favorable to reduce RC delay.

The gate driver 120 may be provided as a gate driver in panel (GIP) type in a bezel region BZ disposed outside the active area AA of the display panel 100 and may supply the gate lines GL of the display panel 100 with gate signals where phases thereof are sequentially shifted, based on control by the timing controller 130. The gate driver 120 may output a gate signal needed for pixel driving and may shift the gate signal by pixel row units.

The pixel row L1 to Ln charged with data voltages may be selected based on a gate signal. To this end, pixels SP disposed in a corresponding pixel row L1 to Ln may be simultaneously activated based on the gate signal. The gate signal may include a plurality of scan signals, which swing between an on level and an off level, and an emission control signal. The gate driver 120 may include a plurality of scan drivers which generate the plurality of scan signals and an emission driver which generates the emission control signal.

The timing controller 130 may receive video data DATA and a timing signal, synchronized with the video data DATA, from a host system (not shown). The timing signal may include a vertical synchronization signal Vsync, a horizontal synchronization signal Hsync, a clock signal DCLK, and a data enable signal DE. The vertical synchronization signal Vsync may define a vertical period. The horizontal synchronization signal Hsync may define a horizontal period. The data enable signal DE may define a time where the video data DATA is transferred, in a vertical period or a horizontal period. The vertical period and the horizontal period may be determined by a method of counting the data enable signal DE, and thus, the vertical synchronization signal Vsync and the horizontal synchronization signal Hsync may be omitted.

The timing controller 130 may generate a source timing control signal DDC for controlling an operation timing of the source driver 110 and a gate timing control signal GDC for controlling an operation timing of the gate driver 120, based on the timing signal Vsync, Hsync, and DE received from the host system. The timing controller 130 may further control an operation timing of the reset voltage control circuit 200 by using the timing signal Vsync, Hsync, and DE.

The host system may be one of a television (TV), a set-top box, a navigation system, a personal computer (PC), a home theater, an automotive display system, a mobile device, and a wearable device.

A level shifter 140 may convert a voltage of the gate timing control signal GDC, output from the timing controller 130, into an on-level voltage and an off-level voltage and may supply the on-level voltage and the off-level voltage to the gate driver 120.

In mobile devices and wearable devices, the source driver 110, the timing controller 130, the level shifter 140, and the reset voltage control circuit 200 may be integrated into one drive IC.

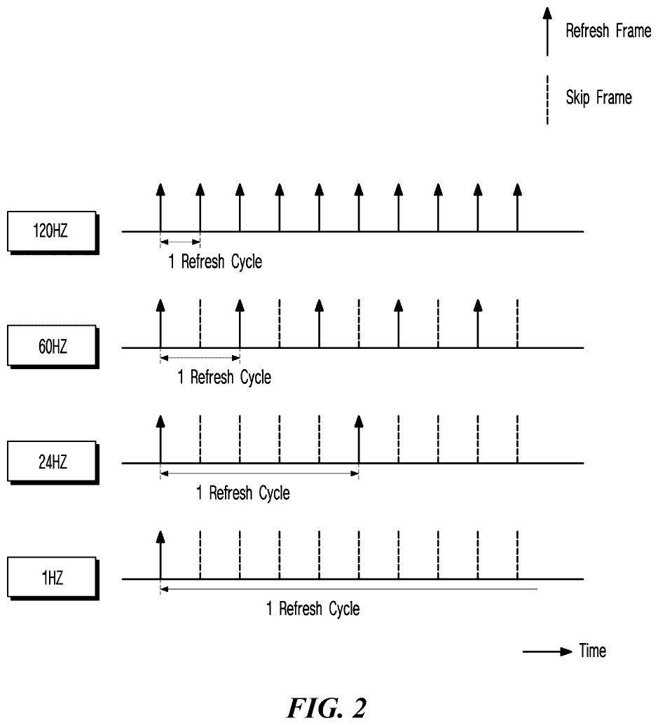

FIG. 2 is a diagram illustrating an example of VRR technology applied to a display device according to an embodiment of the present disclosure.

Referring to FIG. 2, a data refresh cycle implemented in pixels of a display panel may vary based on an attribute of an input image. The data refresh cycle may decrease when the amount of variation of an image is large, and when the amount of variation of the image is small, the data refresh cycle may increase. As the data refresh cycle increases, low-speed driving may be performed, and as the data refresh cycle decreases, high-speed driving may be performed.

The data refresh cycle may be 1/frame frequency. For example, the data refresh cycle may be 1 sec/120 in 120 Hz, 1 sec/60 in 60 Hz, 1 sec/24 in 24 Hz, and 1 sec in 1 Hz.

The number of skip frames provided between two adjacent refresh frames may vary based on a frame frequency. For example, the number of skip frames may be 0 in 120 Hz, 1 in 60 Hz, 4 in 24 Hz, and 119 in 1 Hz.

Due to a leakage characteristic variation occurring in pixels, a luminance deviation between frames may occur. Such a luminance deviation is more noticeable in low-speed driving where a data refresh cycle is long, and due to this, a flicker characteristic may decrease (i.e., the amount of flickers may increase).

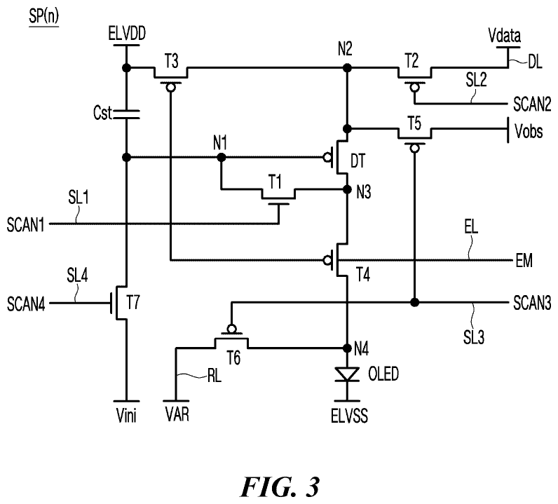

FIG. 3 is a diagram illustrating a pixel SP(n) disposed in an n^{th} pixel row Ln according to an embodiment of the present disclosure.

Referring to FIG. 3, the pixel SP(n) disposed in the n^{th} pixel row Ln may be implemented with a pixel circuit which includes a light emitting element OLED, a driving transistor DT, switch transistors (for example, first to seventh switch transistors) T1 to T7, and a capacitor Cst.

The driving transistor DT, the switch transistors T1 to T7, and the capacitor Cst may control a driving current flowing in the light emitting element OLED to drive the light emitting element OLED. Each of the driving transistor DT and the switch transistors T1 to T7 may include a first electrode, a second electrode, and a gate electrode. One of the first electrode and the second electrode may be a source electrode, and the other of the first electrode and the second electrode may be a drain electrode.

Each of the second to sixth transistors T2 to T6 and the driving transistor DT may be implemented as a PMOS type including a semiconductor layer having LTPS, which is good in response characteristic. On the other hand, the first and seventh transistors T1 and T7 directly connected to a gate electrode of the driving transistor DT may be implemented as an NMOS type including an oxide semiconductor layer which is good in off characteristic.

An on level voltage of the PMOS-type transistor may be a gate low voltage, and an off level voltage may be a gate high voltage. On the other hand, an on level voltage of the NMOS-type transistor may be a gate high voltage, and an off level voltage may be a gate low voltage.

The light emitting element OLED may include an anode electrode (or a pixel electrode), a cathode electrode (or a common electrode), and an organic compound layer (configured with a common layer and an emission layer) disposed therebetween. The anode electrode of the light emitting element OLED may be connected to a fourth node N4, and the cathode electrode of the light emitting element OLED may be connected to a second power voltage ELVSS.

The driving transistor DT may include a gate electrode connected to the first node N1, a source electrode connected to a second node N2, and a drain electrode connected to a third node N3. The driving transistor DT may generate the driving current based on a voltage of the first node N1 (or a data voltage stored in the capacitor Cst) and may apply the driving current to the light emitting element OLED.

The first switch transistor T1 may include a gate electrode receiving a first scan signal SCAN1 through a first scan line SL1, a drain electrode connected to the third node N3, and a source electrode connected to the first node N1. The first switch transistor T1 may be turned on in response to the first scan signal SCAN1 and may short-circuit the gate electrode and the drain electrode of the driving transistor DT with each other. Accordingly, the driving transistor DT may operate like a diode while the first switch transistor T1 is being turned on.

The second switch transistor T2 may include a gate electrode receiving a second scan signal SCAN2 through a second scan line SL2, a source electrode connected to a data line (or receiving a data voltage Vdata), and a drain electrode connected to the second node N2. The second switch transistor T2 may be turned on in response to the second scan signal SCAN2 and may transfer the data voltage Vdata to the second node N2.

The capacitor Cst may be connected between the first node N1 and an input terminal of the first power voltage ELVDD. The capacitor Cst may hold a voltage of the first node N1.

The third and fourth switch transistors T3 and T4 may be connected between the first power voltage ELVDD and the light emitting diode OLED and may form a current movement path through which the driving current generated by the driving transistor DT moves.

The third switch transistor T3 may include a source electrode connected to the input terminal of the first power voltage ELVDD, a drain electrode connected to the second node N2, and a gate electrode which receives an emission control signal EM through an emission control line EL. The fourth switch transistor T4 may include a source electrode connected to the third node N3, a drain electrode connected to the fourth node N4, and a gate electrode which receives the emission control signal EM through the emission control line EL.

The third and fourth switch transistors T3 and T4 may be turned on in response to the emission control signal EM. While the third and fourth switch transistors T3 and T4 are being turned on, the light emitting element OLED may receive the driving current from the driving transistor DT and may emit light with brightness corresponding to the driving current.

The fifth switch transistor T5 may include a source electrode connected to an input terminal of an OBS voltage Vobs, a second electrode connected to the second node N2, and a gate electrode which receives a third scan signal SCAN3 through a third scan line SL3. The fifth switch transistor T5 may be turned on based on the third scan signal SCAN3 and may apply the OBS voltage Vobs to the second node N2.

The sixth switch transistor T6 may include a source electrode connected to an input terminal of an anode reset voltage VAR, a drain electrode connected to the fourth node N4, and a gate electrode which receives the third scan signal SCAN3 through the third scan line SL3. The sixth switch transistor T6 may be turned on based on the third scan signal SCAN3 and may transfer the anode reset voltage VAR to the fourth node N4.

The seventh switch transistor T7 may include a source electrode connected to an input terminal of an initialization voltage Vini, a second electrode connected to the first node N1, and a gate electrode which receives a fourth scan signal SCAN4 through a fourth scan line SL4. The seventh switch transistor T7 may be turned on based on the fourth scan signal SCAN4 and may apply the initialization voltage Vini to the first node N1.

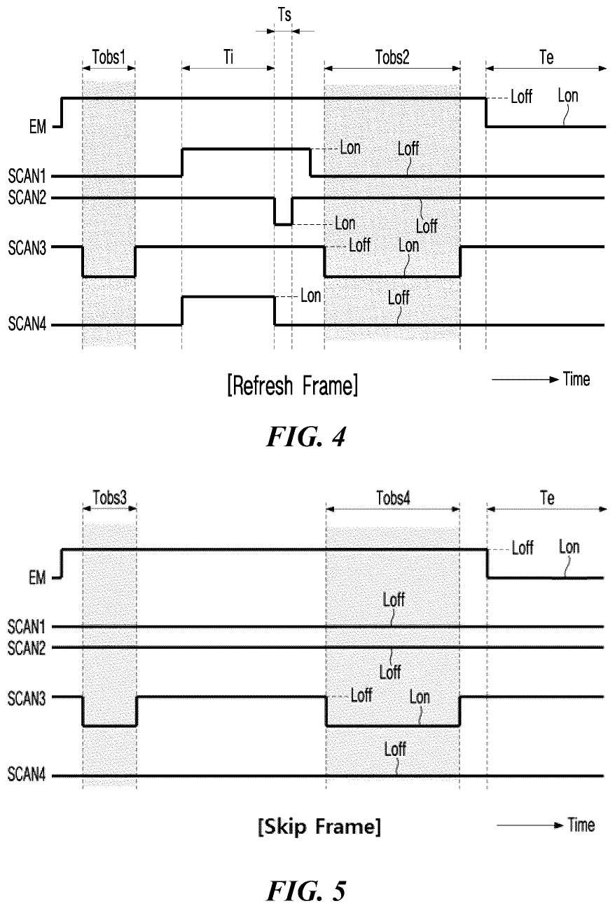

FIG. 4 is a driving waveform diagram of a pixel in a refresh frame.

Referring to FIG. 4, a first OBS period Tobs1, an initialization period Ti, a programming period Ts, a second OBS period Tobs2, and an emission period Te may be time-serially arranged in the refresh frame.

The second scan signal SCAN2 may define the programming period Ts where a data voltage Vdata is supplied. The programming period Ts may be an on level (Lon) period of a second scan signal SCAN2.

The third scan signal SCAN3 may define a first OBS period Tobs1 preceding the programming period Ts and a second OBS period Tobs2 succeeding the programming period Ts and preceding the emission period Te. The first OBS period Tobs1 and the second OBS period Tobs2 may each be an on level (Lon) period of the third scan signal SCAN3.

The fourth scan signal SCAN4 may define an initialization period Ti which is arranged between the first OBS period Tobs1 and the programming period Ts. The initialization period Ti may be an on level (Lon) period of the fourth scan signal SCAN4.

The emission control signal EM may define an emission period Te succeeding the second OBS period Tobs2. The emission period Te may be an on level (Lon) period of the emission control signal EM.

The first OBS period Tobs1, the initialization period Ti, the programming period Ts, and the second OBS period Tobs2 may be arranged in an “EM off period” which is an off level (Loff) period of the emission control signal EM. An “EM on period” which is an on level (Lon) period of the emission control signal EM may be the emission period Te.

Referring to FIGS. 3 and 4, in the first OBS period Tobs1, in response to the third scan signal SCAN3, the fifth and sixth switch transistors T5 and T6 may be turned on, and the other switch transistors T1 to T4 and T7 may be turned off.

In the first OBS period Tobs1, as the fifth switch transistor T5 is turned on, the OBS voltage Vobs may be applied to the second node N2. Based on the OBS voltage Vobs, a drain-source channel of the driving transistor DT may be maximally opened, and the driving transistor DT may maintain a stronger saturation state, and thus, a hysteresis characteristic of the driving transistor DT may be improved prior to data programming.

In the first OBS period Tobs1, as the sixth switch transistor T6 is turned on, the anode reset voltage VAR may be applied to the fourth node N4. Based on the anode reset voltage VAR, residual electric charges in a parasitic capacitor formed between the anode electrode and the cathode electrode of the light emitting element OLED may be reset.

Referring to FIGS. 3 and 4, in the initialization period Ti, in response to the first scan signal SCAN1 and the fourth scan signal SCAN4, the first and seventh switch transistors T1 and T7 may be turned on, and the other switch transistors T2 to T6 may be turned off. As the seventh switch transistor T7 is turned on, the first node N1 may be initialized into the initialization voltage Vini, and as the first switch transistor T1 is turned on, the driving transistor DT may operate like a diode.

Referring to FIGS. 3 and 4, in the programming period Ts, as the first and second switch transistors T1 and T2 are turned on, a threshold voltage sampling operation and a data programming operation may be sequentially or simultaneously performed.

The data voltage Vdata may be applied to the second node N2 through the second switch transistor T2. The data voltage Vdata may be applied to the third node N3 through the driving transistor DT, and then, may be applied to the first node N1 through the first switch transistor T1. The driving transistor DT may operate like a diode in a state where the first switch transistor T1 is turned on, an electric potential at the gate electrode of the driving transistor DT connected to the first node N1 may be programmed to be “Vdata−|Vth|.” A threshold voltage Vth may be sampled and reflected in a programmed electric potential at the gate electrode of the driving transistor DT.

Referring to FIGS. 3 and 4, in the second OBS period Tobs2, in response to the third scan signal SCAN3, the fifth and sixth switch transistors T5 and T6 may be turned on, and the other switch transistors T1 to T4 and T7 may be turned off.

In the second OBS period Tobs2, as the fifth switch transistor T5 is turned on, the OBS voltage Vobs may be applied to the second node N2. Based on the OBS voltage Vobs, a drain-source channel of the driving transistor DT may be maximally opened, and the driving transistor DT may maintain a stronger saturation state, and thus, a hysteresis characteristic of the driving transistor DT may be re-recovered prior to the emission of light.

In the second OBS period Tobs2, as the sixth switch transistor T6 is turned on, the anode reset voltage VAR may be applied to the fourth node N4, and thus, residual electric charges in a parasitic capacitor of the light emitting element OLED may be re-reset.

Referring to FIGS. 3 and 4, in the emission period Te, in response to the emission control signal EM, the third and fourth switch transistors T3 and T4 may be turned on, and the other switch transistors T1, T2, T5, T6, and T7 may be turned off.

In the emission period Te, a driving current supplied from the driving transistor DT to the light emitting element OLED may be based on Vgs of the driving transistor DT set in the programming period Ts. The driving current may be irrelevant to a threshold voltage of the driving transistor DT and may be associated with the data voltage Vdata.

FIG. 5 is a diagram showing a driving waveform of a pixel in a skip frame.

Referring to FIG. 5, a third OBS period Tobs3, a fourth OBS period Tobs4, and an emission period Te may be time-serially arranged in the skip frame.

The emission control signal EM may define the emission period Te of the skip frame. The emission period Te may be an on level (Lon) period of the emission control signal EM. An on level (Lon) period of the emission control signal EM in the skip frame may be substantially the same as the refresh frame.

The third scan signal SCAN3 may further define the third OBS period Tobs3 and the fourth OBS period Tobs4 which are sequentially arranged before the emission period Te, in the skip frame. In the skip frame, the third OBS period Tobs3 and the fourth OBS period Tobs4 may each be an on level (Lon) period of the third scan signal SCAN3.

Furthermore, the initialization period and the programming period may not be needed in the skip frame, and moreover, the third OBS period Tobs3 may be skipped.

Referring to FIGS. 3 and 5, a hysteresis characteristic of the driving transistor DT may be re-improved in the third OBS period Tobs3 and the fourth OBS period Tobs4, and thus, a hysteresis characteristic deviation between the skip frame and the refresh frame may be reduced.

The first and second OBS periods Tobs1 and Tobs2 of the refresh frame may be included in the EM off period, and moreover, the third and fourth OBS periods Tobs3 and Tobs4 of the skip frame may be included in the EM off period.

An EM off period may be set to be equal to each other in the refresh frame and the skip frame, and thus, a length of an emission maintenance time may be equal to each other in the refresh frame and the skip frame.

FIG. 6 is a diagram illustrating a relationship between an anode reset voltage and a gray response time of a light emitting element at a scene change time.

Referring to FIG. 6, in the OBS periods described above, an anode reset voltage VAR may be applied to an anode electrode of a light emitting element OLED, based on a third scan signal SCAN3. A parasitic capacitor Coled of the light emitting element OLED may be reset by the anode reset voltage VAR. Accordingly, the anode reset voltage VAR may be a voltage which initializes the parasitic capacitor Coled of the light emitting element OLED.

Under a gray falling condition where a display image of an active area is changed from a white image to a black image, a scene change time (e.g., in a black image frame) may vary according to a level of the anode reset voltage VAR. For example, as illustrated in FIG. 6, a discharge effect on a parasitic capacitor of a light emitting element may increase in an anode reset voltage VAR of −12.6 V compared to an anode reset voltage VAR of −10.6 V, and thus, black gray expression may be enhanced. In other words, under the gray falling condition, as the anode reset voltage VAR is set to be lower, a gray response (or a gray response time) of a scene change time may be improved.

On the other hand, in this case, because a second power voltage ELVSS and the anode reset voltage VAR should be reduced together for a normal operation, the consumption of power in the light emitting element OLED may increase. The description herein provides a method of implementing low power consumption while increasing a gray response of a scene change time.

FIG. 7 is a diagram illustrating an example where an anode reset voltage is changed to be different from a default level at only a scene change time, and the anode reset voltage is maintained at the default level at the other time.

Referring to FIG. 7, under a gray falling condition where a display image of an active area is changed from a white image to a black image, when an anode reset voltage VAR is maintained at a default level VL1, blurring (for example, a trailing shadow) caused by a slow gray response at a scene change time SCT may be recognized.

To implement low power consumption while increasing a gray response of the scene change time SCT, a reset voltage control circuit according to the present disclosure may down-shift the anode reset voltage VAR to a second level VL2 which is lower than the default level VL1, at only the scene change time SCT, and may recover the anode reset voltage VAR to the default level VL1 at the other time.

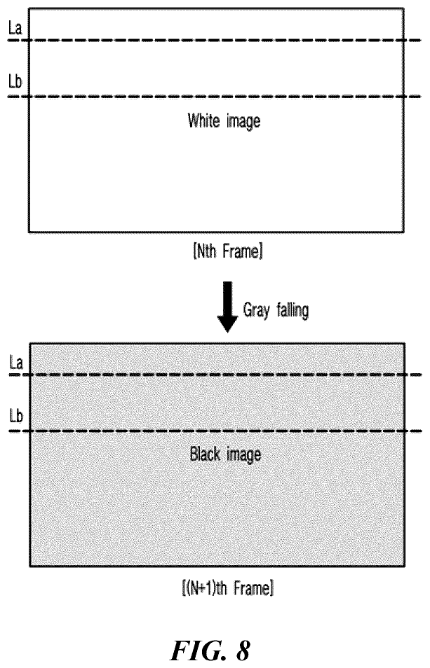

This will be additionally described with reference to FIGS. 8 to 10.

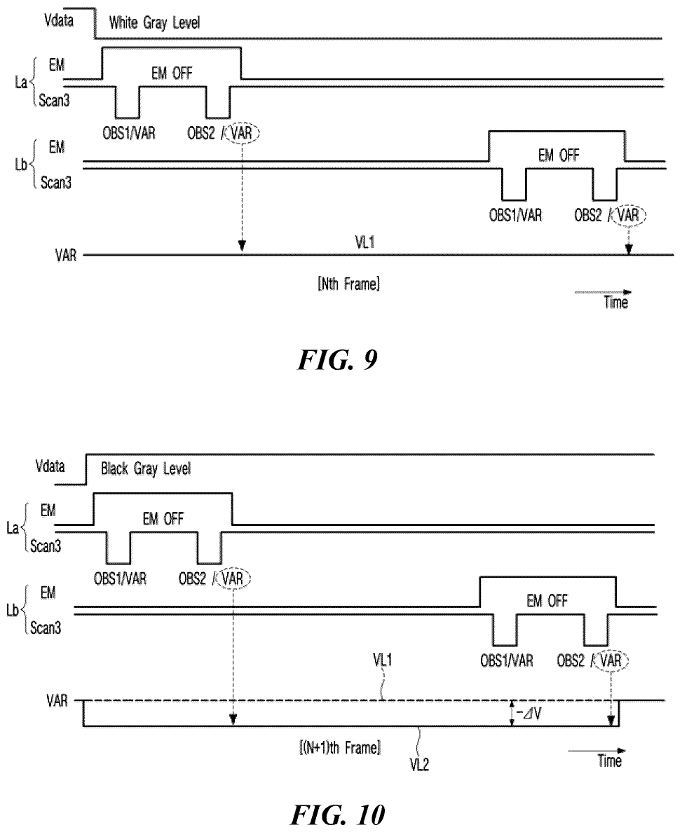

FIG. 8 illustrates a gray falling condition of a scene change time SCT where an image gray level is changed from a white image of an N^{th} frame to a black image of an (N+1)^{th} frame. FIG. 9 illustrates a case where an anode reset voltage VAR is maintained at a default level VL1 in an N^{th} frame just before the scene change time of FIG. 8. FIG. 10 illustrates a case where an anode reset voltage VAR is down-shifted from a default level VL1 to a second level VL2 in an (N+1)^{th} frame corresponding to the scene change time SCT of FIG. 8.

Referring to FIGS. 8 and 9, an anode reset voltage VAR corresponding to all pixel rows La and Lb in an N^{th} frame just before a scene change time may be maintained at the default level VL1. In OBS periods overlapping an EM off period, an anode reset voltage VAR of the default level VL1 may be supplied to pixels of all pixel rows La and Lb.

Referring to FIGS. 8 and 10, an anode reset voltage VAR corresponding to all pixel rows La and Lb in an (N+1)^{th} frame corresponding to the scene change time may be down-shifted from the default level VL1 to the second level VL2 which is ΔV lower than the default level VL1. In OBS periods overlapping an EM off period, an anode reset voltage VAR of the second level VL2 may be supplied to pixels of all pixel rows La and Lb.

As shown in FIG. 10, in order to decrease the consumption of power consumed in a light emitting element, the anode reset voltage VAR may be recovered to the default level VL1 in an (N+2)^{th} frame ((N+2)^{th} frame not shown in FIG. 10) after the scene change time.

Furthermore, an anode reset voltage being temporarily changed to be different from a default level at only a scene change time and recovers the anode reset voltage to the default level after the scene change time may be implemented for the gray falling condition where an image is changed from a white image to a block image, and may also be implemented for a gray rising condition of the scene change time SCT where an image is changed from a black image to a white image.

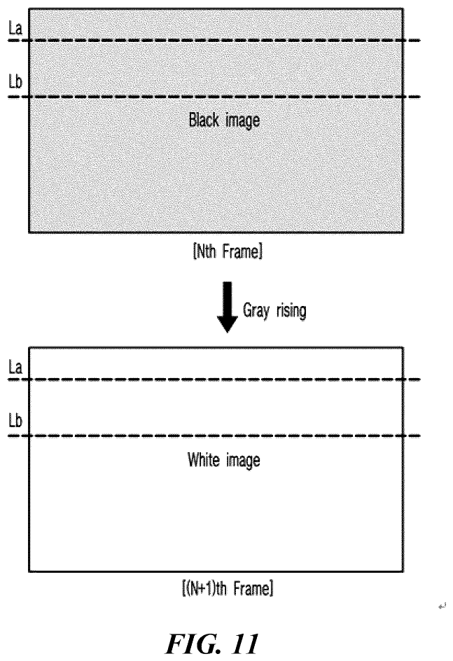

This will be additionally described with reference to FIGS. 11 to 13.

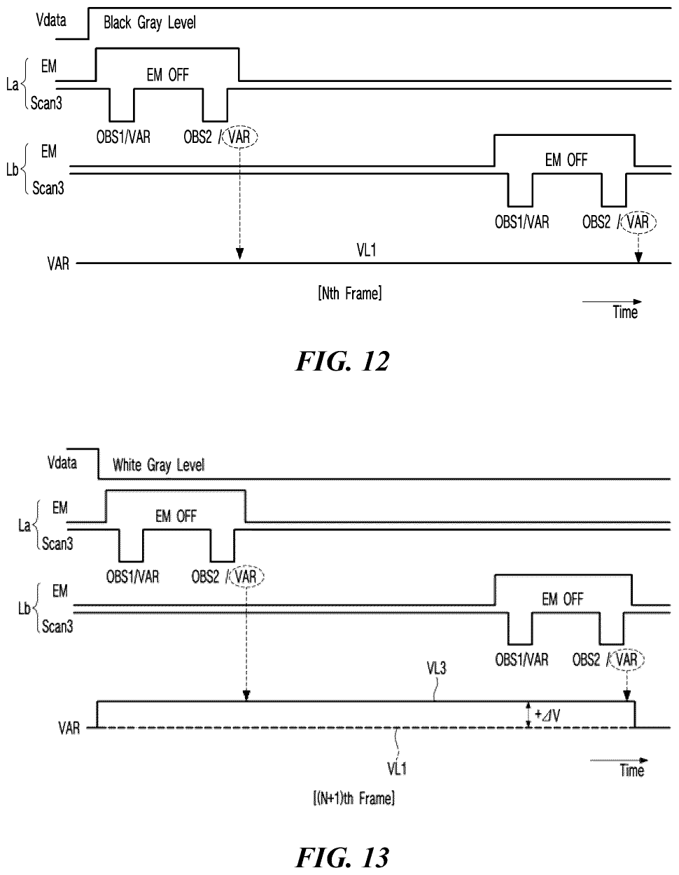

FIG. 11 illustrates a gray rising condition of a scene change time SCT where an image gray level is changed from a black image of an N^{th} frame to a white image of an (N+1)^{th} frame. FIG. 12 illustrates a case where an anode reset voltage VAR is maintained at a default level VL1 in an N^{th} frame just before the scene change time of FIG. 11. FIG. 13 illustrates a case where an anode reset voltage VAR is up-shifted from a default level VL1 to a third level VL3 in an (N+1)^{th} frame corresponding to the scene change time SCT of FIG. 11.

Referring to FIGS. 11 and 12, an anode reset voltage VAR corresponding to all pixel rows La and Lb in an N^{th} frame just before a scene change time may be maintained at the default level VL1. In OBS periods overlapping an EM off period, an anode reset voltage VAR of the default level VL1 may be supplied to pixels of all pixel rows La and Lb.

Referring to FIGS. 11 and 13, an anode reset voltage VAR corresponding to all pixel rows La and Lb in an (N+1)^{th} frame corresponding to the scene change time SCT may be up-shifted from the default level VL1 to the third level VL3 which is ΔV higher than the default level VL1. In OBS periods overlapping an EM off period, an anode reset voltage VAR of the third level VL3 may be supplied to pixels of all pixel rows La and Lb.

as shown in FIG. 13, in order to decrease the consumption of power consumed in a light emitting element, the anode reset voltage VAR may be recovered to the default level VL1 in an (N+2)^{th} frame ((N+2)^{th} frame not shown in FIG. 13) after the scene change time.

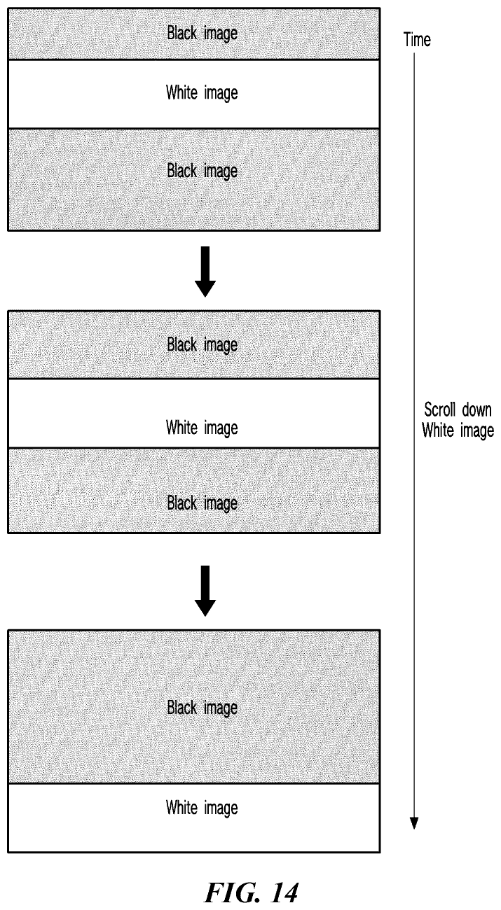

Furthermore, the techniques of temporarily changing an anode reset voltage to be different from a default level may be applied to a scroll-down image where both a gray falling operation and a gray rising operation are performed in different portions of an active area as in FIGS. 14 to 19.

Referring to FIG. 14, a white image pattern may be scrolled down in one active area for a scene change time with a black image as a background. The white image pattern may be implemented with pixels of a partial region of the active area. Based on a scroll-down operation, a position of a white image pattern may be shifted in a direction toward a lower end of an active area from an upper end of the active area. Accordingly, a gray falling position and a gray rising position of one screen may both appear in different regions, e.g., rows, of the active area.

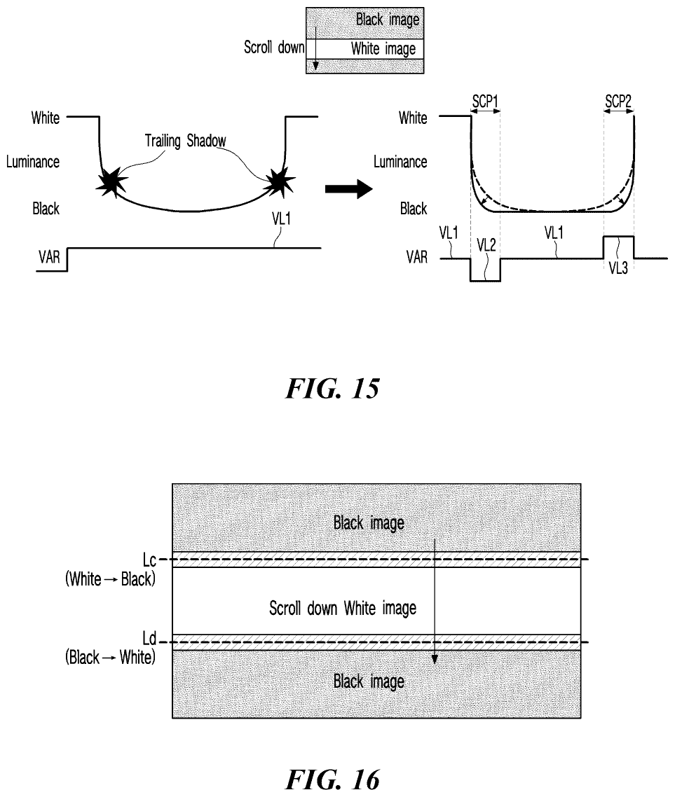

Referring to FIG. 15, a reset voltage control circuit according to an embodiment of the present disclosure may change an anode reset voltage VAR to be different from a default level VL1 at a gray falling position SCP1 and a gray rising position SCP2 of a scene change time and may recover the anode reset voltage VAR to the default level VL1 at the other position.

At the scene change time, the reset voltage control circuit may change the anode reset voltage VAR to a second level VL2 which is lower than the default level VL1, and then, may supply an anode reset voltage VAR of the second level VL2 to pixels of some pixel rows (for example, a first pixel row) satisfying a gray falling condition.

At the scene change time, the reset voltage control circuit may change the anode reset voltage VAR to a third level VL3 which is higher than the default level VL1, and then, may supply an anode reset voltage VAR of the third level VL3 to pixels of some pixel rows (for example, a second pixel row) satisfying a gray rising condition.

Referring to FIG. 16, based on a scroll-down operation of a white image pattern with a black image as a background, a gray falling position Lc and a gray rising position Ld of a scene change temporally.

The gray falling position Lc may be implemented in at least one first pixel row. An image gray level implemented in the first pixel row for the scene change time may be changed from a white image to a black image through the scroll-down operation and may thus satisfy a gray falling condition.

The gray rising position Ld may be implemented in at least one second pixel row. An image gray level implemented in the second pixel row for the scene change time may be changed from a black image to a white image through the scroll-down operation and may thus satisfy a gray rising condition.

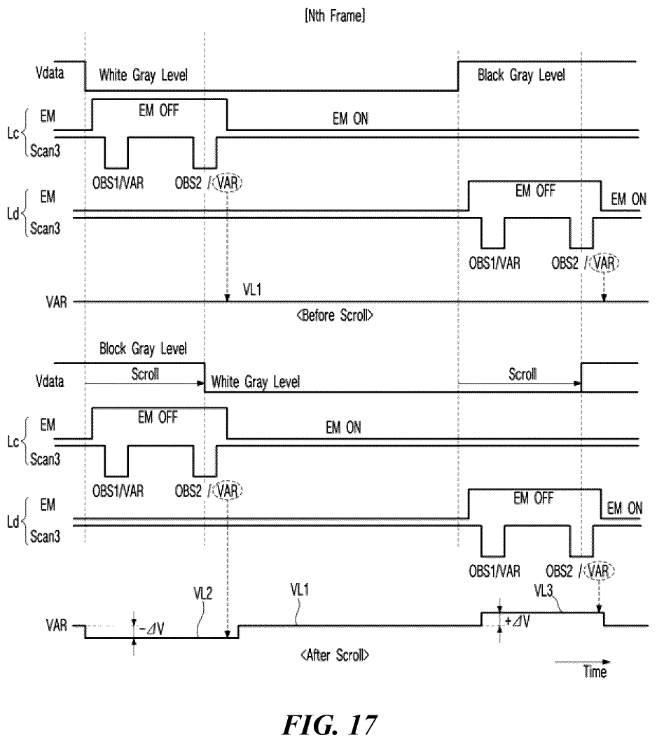

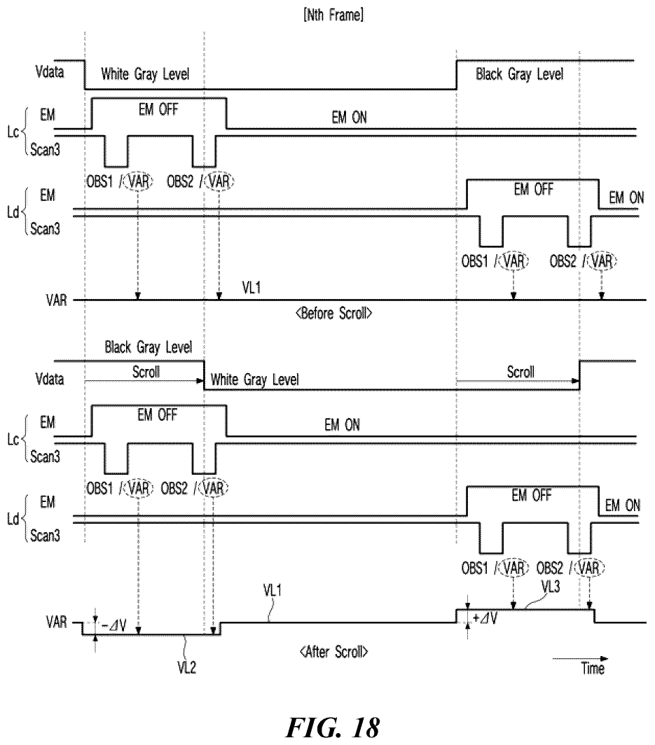

FIGS. 17 and 18 illustrate an example where an anode reset voltage is differently changed at a gray falling position and a gray rising position based on a scroll-down operation in an N^{th} frame in the middle of a scene change time.

Referring to FIG. 17, the reset voltage control circuit may change an anode reset voltage VAR to a second level VL2 which is lower than a default level VL1, and then, may supply an anode reset voltage VAR of the second level VL2 to pixels of a gray falling position Lc during a second OBS period of a scene change time.

Referring to FIG. 17, the reset voltage control circuit may change the anode reset voltage VAR to a third level VL3 which is higher than the default level VL1, and then, may supply an anode reset voltage VAR of the third level VL3 to pixels of a gray rising position Ld during the second OBS period of the scene change time.

Referring to FIG. 18, the reset voltage control circuit may change the anode reset voltage VAR to the second level VL2 which is lower than the default level VL1, and then, may supply the anode reset voltage VAR of the second level VL2 to the pixels of the gray falling position Lc during first and second OBS periods of the scene change time.

Referring to FIG. 18, the reset voltage control circuit may change the anode reset voltage VAR to the third level VL3 which is higher than the default level VL1, and then, may supply the anode reset voltage VAR of the third level VL3 to the pixels of the gray rising position Ld during the first and second OBS periods of the scene change time.

A level of an anode reset voltage VAR just before an EM on period starts may be significant for increasing a gray response of a light emitting element at a scene change time. Therefore, as in FIG. 17, the reset voltage control circuit may supply the anode reset voltage VAR to be different from the default level VL1 in only the second OBS period, or as in FIG. 18, the reset voltage control circuit may supply the anode reset voltage VAR to be different from the default level VL1 in only the first and second OBS periods. Based on the gray falling/rising positions Lc and Ld, the reset voltage control circuit may recover the anode reset voltage VAR to the default level VL1 at a time after the second OBS period.

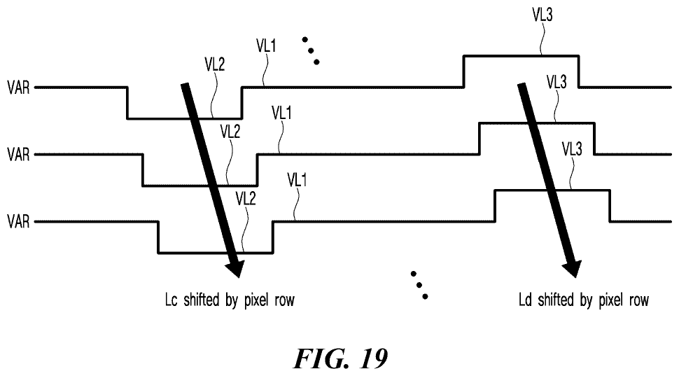

Referring to FIG. 19, an anode reset voltage VAR may be changed based on a gray falling position Lc and a gray rising position Ld shifted in a pixel row unit.

The anode reset voltage VAR may be down-shifted from a default level VL1 to a second level VL2 and may then be recovered to the default level VL1, based on the gray falling position Lc. Also, the anode reset voltage VAR may be up-shifted from the default level VL1 to a third level VL3 and may then be recovered to the default level VL1, based on the gray rising position Ld.

To differently express this, the gray falling position Lc at which an anode reset voltage VAR of the second level VL2 is supplied and the gray rising position Ld at which an anode reset voltage VAR of the third level VL3 is supplied may be sequentially shifted in a pixel row unit through a plurality of scene change times. The anode reset voltage VAR may be recovered to the default level VL1 in subsequent frames succeeding scene change times.

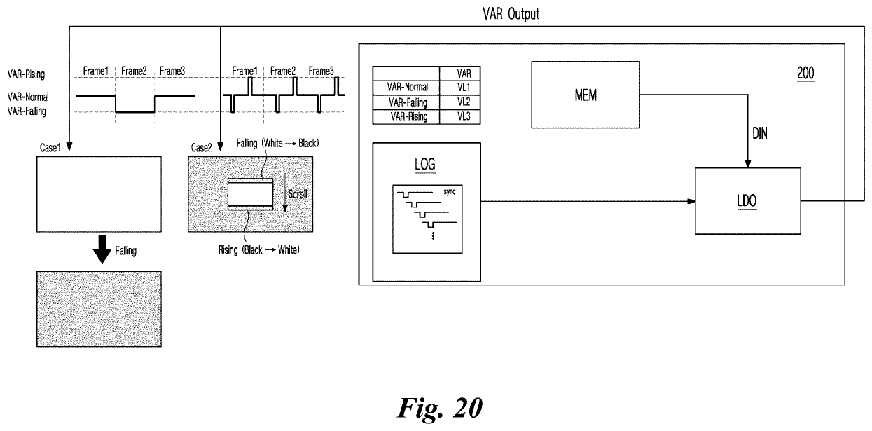

FIG. 20 is a diagram illustrating a configuration of a reset voltage control circuit 200.

Referring to FIG. 20, the reset voltage control circuit 200 may include a memory MEM, an image change detector LOG, and a reset voltage output unit LDO.

The memory MEM may store voltage level information about a default level VL1, a second level VL2 which is lower than the default level VL1, and a third level VL3 which is higher than the default level VL1.

The image change detector LOG may detect, in a target region unit, the amount of image gray variation of a current frame with respect to a previous frame. The target region may be set to be all pixel rows of an active area (a case 1 of FIG. 20), or may be set to be one pixel row of the active area (a case 2 of FIG. 20).

The reset voltage output unit LDO may select voltage level information about one of the default level VL1, the second level VL2, and the third level VL3 in a target region unis, based on the amount of image gray variation, and may output, in a target region unit, an anode reset voltage VAR corresponding to selected voltage level information DIN.

FIG. 21 is a diagram illustrating a connection configuration between a reset voltage control circuit 200, a gamma memory G-MEM, a gamma voltage circuit CRGM, and a source driver 110. FIG. 22 is a diagram illustrating a configuration of the gamma memory G-MEM.

Referring to FIG. 21, the source driver 110 may include a data latch LAT, a digital-to-analog converter DAC, and an output unit OCH.

The data latch LAT may latch and temporarily store, in a pixel row unit, digital image data transferred from a timing controller.

The digital-to-analog converter DAC may map the digital image data, input from the data latch LAT, to gamma compensation voltages to generate data voltages having different gray values. The digital-to-analog converter DAC may divide gamma reference voltages to generate the gamma compensation voltages. In this case, the gamma reference voltages may be supplied from the gamma voltage circuit CRGM to the digital-to-analog converter DAC.

The output unit OCH may output the data voltages to data lines.

Referring to FIGS. 21 and 22, the gamma voltage circuit CRGM may generate gamma tap voltages V1, V2, V6, V13, . . . , and V250 and may supply the gamma tap voltages V1, V2, V6, V13, . . . , and V250 as the gamma reference voltages to the digital-to-analog converter DAC. The gamma tap voltages V1, V2, V6, V13, . . . , and V250 may be about 10 to 16 gamma reference voltages included in 256 gamma compensation voltages representing 0 (black gray level) to 255 (white gray level) gray levels.

The gamma voltage circuit CRGM may operate in connection with the reset voltage control circuit 200. The reset voltage control circuit 200 may be the same as the description of FIG. 20.

The gamma voltage circuit CRGM may generate the gamma tap voltages V1, V2, V6, V13, . . . , and V250 independently of red (R), green (G), and blue (B), with reference to tap voltage information about the gamma memory G-MEM, and in this case, the gamma voltage circuit CRGM may output the gamma tap voltages V1, V2, V6, V13, . . . , and V250 applied to a scene change time to be different from gamma tap voltages V1, V2, V6, V13, . . . , and V250 applied to the other frame except the scene change time. Accordingly, a problem where color coordinates are warped due to a variation of the anode reset voltage VAR at the scene change time may be prevented.

The gamma memory G-MEM, as in FIG. 22, may store tap voltage information which includes a plurality of first gamma tap voltages RGM1 corresponding to a default condition, a plurality of second gamma tap voltages RGM2 corresponding to a gray falling condition where an image gray level of a target region of an active area is changed from a white image to a black image, and a plurality of third gamma tap voltages RGM3 corresponding to a gray rising condition where the image gray level of the target region of the active area is changed from the black image to the white image.

When an anode reset voltage VAR_Normal of a default level VL1 matches the target region of the active area under a default condition, the gamma voltage circuit CRGM may generate first gamma tap voltages RGM1 and may output the first gamma tap voltages RGM1 as gamma reference voltages to the digital-to-analog converter DAC.

When an anode reset voltage VAR_Falling of a lower second level VL2 than the default level VL1 matches the target region of the active area under a gray falling condition, the gamma voltage circuit CRGM may generate second gamma tap voltages RGM2 and may output the second gamma tap voltages RGM2 as gamma reference voltages to the digital-to-analog converter DAC.

When an anode reset voltage VAR_Rising of a higher third level VL3 than the default level VL1 matches the target region of the active area under a gray rising condition, the gamma voltage circuit CRGM may generate third gamma tap voltages RGM3 and may output the third gamma tap voltages RGM3 as gamma reference voltages to the digital-to-analog converter DAC.

The image gray level may include a low gray range including a determined low gray level (the low grey level can be dynamically or experimentally determined or set) and the other gray range except the low gray range. Due to this, a problem where color coordinates are warped due to a variation of the anode reset voltage VAR at the scene change time may be more deteriorated in the low gray range.

To solve such a problem, a level of one of the first gamma tap voltages RGM1, a level of one of the second gamma tap voltages RGM2, and a level of one of the third gamma tap voltages RGM3, corresponding to the same color and the same gray level, may be differently set in the gamma memory G-MEM in the low gray range. For example, an R color of FIG. 22 and A of RGM1, A′ of RGM2, and A″ of RGM3 each corresponding to a gamma tap voltage V1 may be set to have different magnitudes, a B color of FIG. 22 and B of RGM1, B′ of RGM2, and B″ of RGM3 each corresponding to the gamma tap voltage V1 may be set to have different magnitudes, and a G color of FIG. 22 and C of RGM1, C′ of RGM2, and C″ of RGM3 each corresponding to the gamma tap voltage V1 may be set to have different magnitudes.

On the other hand, a level of one of the first gamma tap voltages RGM1, a level of one of the second gamma tap voltages RGM2, and a level of one of the third gamma tap voltages RGM3, corresponding to the same color and the same gray level, may be identically set in the gamma memory G-MEM in the other gray range except the low gray range. For example, the R color of FIG. 22 and X of RGM1, X′ of RGM2, and X″ of RGM3 each corresponding to a gamma tap voltage V250 may be set to have the same magnitude, the B color of FIG. 22 and Y of RGM1, Y′ of RGM2, and Y″ of RGM3 each corresponding to the gamma tap voltage V250 may be set to have the same magnitude, and the G color of FIG. 22 and Z of RGM1, Z′ of RGM2, and Z″ of RGM3 each corresponding to the gamma tap voltage V250 may be set to have the same magnitude.

The present disclosure may realize the following effects.

In the present disclosure, an anode reset voltage for discharging light emitting elements of pixels may be changed to be different from a default level at a scene change time where the amount of image gray variation is a reference value or more with respect to at least a partial region of an active area, and thus, a discharge effect on a parasitic capacitor of a light emitting element may increase, thereby enhancing display quality and a gray response time of a light emitting element.

In the present disclosure, because the anode reset voltage is changed to be different from the default level at only the scene change time, and the anode reset voltage is recovered to the default level in the other frame except the scene change time, thereby reducing a problem where power consumption increases due to a change in anode reset voltage.

In the present disclosure, gamma tap voltages applied to the scene change time may be output to be different from gamma tap voltages applied to the other frame except the scene change time, and thus, may prevent a problem where color coordinates are warped because the anode reset voltage is changed at the scene change time.

The effects according to the present disclosure are not limited to the above examples, and other various effects may be included in the specification.

While the present disclosure has been particularly shown and described with reference to exemplary embodiments thereof, it will be understood by those of ordinary skill in the art that various changes in form and details may be made therein without departing from the spirit and scope of the present disclosure including those of the following claims.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device comprising:
a display panel including an active area having a plurality of pixels;
a source driver configured to divide gamma reference voltages to generate a data voltage for implementing an image gray level and supply the data voltage to a pixel of the plurality of pixels of the active area; and
a reset voltage control circuit configured to change an anode reset voltage for discharging a light emitting element of a pixel of the plurality of pixels to be different from a first level, at a scene change time where an amount of image gray variation is equal to or greater than a threshold value with respect to at least a partial region of the active area, and supply the anode reset voltage to pixels of the at least partial region of the active area.

2. The display device of claim 1, wherein the reset voltage control circuit recovers the anode reset voltage to the first level in a subsequent frame succeeding the scene change time.

3. The display device of claim 1, further comprising a gate driver configured to generate a scan signal and supply the scan signal to the pixels of the at least partial region for the scene change time,
wherein the scan signal defines a first OBS period and a second OBS period with respect to the pixel of the at least partial region,
the first OBS period and the second OBS period overlap a non-emission period of the pixel of the at least partial region,
the changed anode reset voltage is supplied to the pixels of the at least partial region during the second OBS period,
the first OBS period is arranged prior to a supply time of a data voltage with respect to the pixels of the partial region, and
the second OBS period is arranged between the supply time of the data voltage and an emission time with respect to the pixels of the at least partial region.

4. The display device of claim 1, wherein, under a gray falling condition where an image gray level of a data voltage supplied to the pixels of the at least partial region is shifted from a white image gray level of a previous frame to a black image gray level of the scene change time, the reset voltage control circuit is configured to shift the anode reset voltage to a second level which is lower than the first level, and after the shifting the anode reset voltage to the second level, supply the anode reset voltage of the second level to the pixels of the at least partial region, for the scene change time.

5. The display device of claim 1, wherein, under a gray rising condition where an image gray level of a data voltage supplied to the pixels of the at least partial region is shifted from a black image gray level of a previous frame to a white image gray level of the scene change time, the reset voltage control circuit is configured to shift the anode reset voltage to a third level which is higher than the first level, and after the shifting the anode reset voltage to the third level, supply the anode reset voltage of the third level to the pixels of the at least partial region, for the scene change time.

6. The display device of claim 4, wherein the reset voltage control circuit is configured to supply the anode reset voltage of the second level to pixels of an entire region of the active area including the at least partial region, for the scene change time, and
the anode reset voltage is configured to be recovered to the first level in a frame subsequent to the scene change time.

7. The display device of claim 5, wherein the reset voltage control circuit is configured to supply the anode reset voltage of the third level to pixels of an entire region of the active area including the at least partial region, for the scene change time, and
the anode reset voltage is configured to be recovered to the first level in a frame subsequent to the scene change time.

8. The display device of claim 1, wherein, when a white image corresponding to pixels of a first region of the active area is scrolled down in the active area with a black image corresponding to pixels of a second region of the active area as a background at the scene change time, the reset voltage control circuit is configured to:
shift the anode reset voltage to a second level which is lower than the first level, and after the shifting the anode reset voltage to the second level, supply the anode reset voltage of the second level to pixels of a first pixel row for a gray falling condition, and
shift the anode reset voltage to a third level which is higher than the first level, and after the shifting the anode reset voltage to the third level, supply the anode reset voltage of the third level to pixels of a second pixel row for a gray rising condition,
wherein:
an image gray level implemented in the first pixel row is configured to be shifted from the white image to the black image by the scroll-down for the gray falling condition, and
an image gray level implemented in the second pixel row is configured to be shifted from the black image to the white image by the scroll-down for the gray rising condition.

9. The display device of claim 8, wherein, through a plurality of scene change times,
a position of the first pixel row to which the anode reset voltage of the second level is supplied and a position of the second pixel row to which the anode reset voltage of the third level is supplied are configured to be sequentially shifted in a pixel row unit, and
the anode reset voltage is configured to be recovered to the first level in a frame subsequent to the plurality of scene change times.

10. The display device of claim 1, wherein the reset voltage control circuit comprises:
a memory configured to store voltage level information about the first level, a second level which is lower than the first level, and a third level which is higher than the first level;
an image change detector configured to detect, in a target region unit, an amount of image gray variation of a current frame with respect to a previous frame; and
a reset voltage output unit configured to select voltage level information about one of the first level, the second level, and the third level in the target region unit, based on the amount of image gray variation, and output, in the target region unit, an anode reset voltage corresponding to the selected voltage level information.

11. The display device of claim 1, further comprising:
a gamma memory configured to store tap voltage information including a plurality of first gamma tap voltages corresponding to a default condition, a plurality of second gamma tap voltages corresponding to a gray falling condition where an image gray level of a target region of the active area is shifted from a white image to a black image, and a plurality of third gamma tap voltages corresponding to a gray rising condition where the image gray level of the target region of the active area is shifted from the black image to the white image; and
a gamma voltage circuit configured to, when an anode reset voltage of the first level matches the target region of the active area under the default condition, generate and output the plurality of first gamma tap voltages as gamma reference voltages to the source driver, when an anode reset voltage of a second level lower than the first level matches the target region of the active area under the gray falling condition, generate and output the plurality of second gamma tap voltages as the gamma reference voltages to the source driver, and when an anode reset voltage of a third level higher than the first level matches the target region of the active area under the gray rising condition, generate and output the plurality of third gamma tap voltages as the gamma reference voltages to the source driver.

12. The display device of claim 10, wherein the target region is set to be all pixel rows of the active area, or is set to be one pixel row of the active area.

13. The display device of claim 11, wherein the image gray level comprises a first gray range including a first gray level and a second gray range including a second grey level, the second grey level greater than the first grey level, and
a level of one of the plurality of first gamma tap voltages, a level of one of the plurality of second gamma tap voltages, and a level of one of the plurality of third gamma tap voltages, corresponding to a same color and a same gray level, differ in the first gray range.

14. The display device of claim 13, wherein a level of one of the plurality of first gamma tap voltages, a level of one of the plurality of second gamma tap voltages, and a level of one of the plurality of third gamma tap voltages, corresponding to a same color and a same gray level, are equal to one another in the second gray range.

15. A driving method of a display device including an active area including a plurality of pixels, the driving method comprising:
dividing gamma reference voltages to generate a data voltage for implementing an image gray level and supplying the data voltage to a pixel of the plurality of pixels of the active area; and
changing an anode reset voltage for discharging a light emitting element of a pixel of the plurality of pixels to be different from a first level, at a scene change time where an amount of image gray variation is equal to or greater than a reference value with respect to a first region of the active area, and supplying the anode reset voltage to pixels of the first region of the active area.

16. The driving method of claim 15, comprising recovering the anode reset voltage to the first level in a frame subsequent to the scene change time.

17. A display device comprising:
a display panel including an active area having a plurality of pixels;
a source driver configured to generate a data voltage for implementing an image gray level and supply the data voltage to a pixel of the plurality of pixels; and
a reset voltage control circuit configured to vary an anode reset voltage to be provided to the pixel among different voltage levels based on a change in the image grey level of the data voltage corresponding to the pixel.

18. The display device of claim 17, wherein the reset voltage control circuit is configured to change the anode reset voltage to a first level lower than a default level when the image grey level of the data voltage changes from white image to black image.

19. The display device of claim 17, wherein the reset voltage control circuit is configured to change the anode reset voltage to a second level higher than a default level when the image grey level of the data voltage changes from block image to white image.

20. The display device of claim 17, wherein the reset voltage control circuit is configured to change a first anode reset voltage to be provided to a first pixel of the plurality of pixels to a first level lower than a default level when a first image grey level of a first data voltage of the first pixel changes from white image to black image, and configured to change a second anode reset voltage to be provided to a second pixel of the plurality of pixels to a second level higher than the default level when a second image grey level of a second data voltage of the second pixel changes from black image to white image.
